(19) United States
(12) Patent Application Publication
(10) Pub. No.: US 2009/0153574 A1
(43) Pub. Date: Jun. 18, 2009

(54) METHOD AND SYSTEM FOR UPDATING FIRMWARE

(75) Inventors: Yu-Pin Chou, Miao-Li Hsien (TW); Tzou-Bo Lin, Taipei City (TW); Chih-Ming Lee, Taipei Hsien (TW); Ming-Syun Wu, Taipei Hsien (TW)

Correspondence Address: MERCHANT & GOULD PC, P.O. BOX 2903, MINNEAPOLIS, MN, 55402-0903, US

(73) Assignee: Realtek Semiconductor Corp., Hsinchu (TW)

(21) Appl. No.: 12/275,912

(22) Filed: Nov. 21, 2008

(30) Foreign Application Priority Data
Nov. 22, 2007 (TW) 096144275

(51) Int. Cl. G09G 5/39

(52) U.S. Cl. 345/531

(57) ABSTRACT

A system for updating firmware through a DisplayPort interface includes a source device with a DisplayPort interface, and a sink device with a DisplayPort interface. The source device includes a storage circuit for storing and providing an updated firmware, and a source device auxiliary channel for outputting the updated firmware with an auxiliary channel signal format. The sink device includes a sink device auxiliary channel for receiving the updated firmware with the auxiliary channel signal format and thereby generating an output signal, an I²C auxiliary channel device servicer for receiving the output signal and generating an I²C protocol updated firmware, and a memory unit for updating firmware according to the I²C protocol updated firmware. A method for updating firmware is also disclosed.

### CROSS-REFERENCE TO RELATED APPLICATION

This application claims priority of Taiwanese application no. 096144275, filed on Nov. 22, 2007.

### BACKGROUND OF THE INVENTION

1. Field of the Invention

This invention relates to a method and system for updating firmware, more particularly to a method and system for updating firmware of a display device.

2. Description of the Related Art

In general, firmware stored in a display control device of a display apparatus is used to determine display parameters and for control of operations of the display apparatus. In practice, firmware is updated to meet user requirements or improve operation of the display apparatus, and updated firmware is typically sent from a transmission port of a personal computer, and through a display data channel of a conventional display apparatus interface such as a Digital Visual Interface, High-Definition Multimedia Interface, etc., for eventual receipt by the display control device. The display data channel is independent from an audio-visual data transmission channel.

Since a DisplayPort interface is of a new generation of digital communication interfaces that does not include the display data channel, the conventional technologies cannot be employed to update firmware in a display control device with the DisplayPort interface. Therefore, there is a need to find alternative ways of updating firmware under the DisplayPort standard.

### SUMMARY OF THE INVENTION

Therefore, an object of the present invention is to provide a method and system for updating firmware under the DisplayPort standard.

According to one aspect of the present invention, there is provided a method for updating firmware through a DisplayPort interface. The method comprises the steps of: providing a source device with a DisplayPort interface; providing a sink device with a DisplayPort interface; and updating firmware of a memory unit through a source device auxiliary channel and a sink device auxiliary channel.

The source device includes a storage circuit for storing and providing an updated firmware, and the source device auxiliary channel for outputting the updated firmware with an auxiliary channel signal format.

The sink device includes the sink device auxiliary channel for receiving the updated firmware with the auxiliary channel signal format and thereby generating an output signal, an Inter-Integrated Circuit (I²C) auxiliary channel device servicer coupled to the sink device auxiliary channel for receiving the output signal and generating an I²C protocol updated firmware, and the memory unit for updating firmware according to the I²C protocol updated firmware.

According to another aspect of the present invention, there is provided a method for updating firmware through a DisplayPort interface. The method comprises the steps of: providing a source device with a transmission interface distinct from a DisplayPort interface; providing a sink device with a DisplayPort interface; and updating firmware of a memory unit through at least two pins of a main link and a sink device auxiliary channel.

The source device includes a storage circuit for storing and providing an updated firmware, and an output circuit that outputs a signal with a predetermined signal format for outputting the updated firmware with the predetermined signal format.

The sink device includes the main link, the sink device auxiliary channel, the sink device using at least two pins of the main link and the sink device auxiliary channel to receive the updated firmware with the predetermined signal format, a selector circuit coupled to the main link and the sink device auxiliary channel for outputting the updated firmware with the predetermined signal format, and the memory unit for updating firmware according to the updated firmware with the predetermined signal format.

According to still another aspect of the present invention, there is provided a method for updating firmware of a sink device with a DisplayPort interface. The method comprises the steps of: providing a source device with a transmission interface distinct from a DisplayPort interface; providing a sink device with a DisplayPort interface; and updating firmware of a memory unit through the transmission interface of the source device and a firmware update channel of the sink device.

The source device includes a storage circuit for storing and providing an updated firmware, and an output circuit that outputs a signal with a predetermined signal format for outputting, via the transmission interface, the updated firmware with the predetermined signal format.

The sink device includes a firmware update channel, that is independent of standard channels of the DisplayPort interface of the sink device, for receiving the updated firmware with the predetermined signal format, and a memory unit coupled to the firmware update channel for updating firmware according to the updated firmware with the predetermined signal format.

According to still another aspect of the present invention, there is provided a method for updating firmware through a DisplayPort interface. The method comprises the steps of: providing a first source device with a DisplayPort interface for providing DisplayPort interface signals; providing a second source device with a transmission interface distinct from a Displayport interface; providing a signal combining device; and providing a sink device with a DisplayPort interface.

The second source device includes a storage circuit for storing and providing an updated firmware, and an output circuit that outputs a signal with a predetermined signal format for outputting the updated firmware with the predetermined signal format.

The signal combining device is coupled to the first and second source devices for combining the DisplayPort interface signals from the first source device and the updated firmware with the predetermined signal format from the second source device into a combined signal.

The sink device is coupled to the signal combining device and includes a signal splitting circuit for extracting the updated firmware with the predetermined signal format from the combined signal, and a memory unit for updating firmware according to the updated firmware with the predetermined signal format.

According to another aspect of the present invention, there is provided a system for updating firmware through a DisplayPort interface. The system comprises a source device with a DisplayPort interface, and a sink device with a DisplayPort interface.

The source device includes a storage circuit for storing and providing an updated firmware, and a source device auxiliary channel for outputting the updated firmware with an auxiliary channel signal format.

The sink device includes a sink device auxiliary channel for receiving the updated firmware with the auxiliary channel signal format and thereby generating an output signal, an Inter-Integrated Circuit (I²C) auxiliary channel device servicer coupled to the sink device auxiliary channel for receiving the output signal and generating an I²C protocol updated firmware, and a memory unit for updating firmware according to the I²C protocol updated firmware.

According to still another aspect of the present invention, there is provided a system for updating firmware through a DisplayPort interface. The system comprises a source device with a transmission interface distinct from DisplayPort interface, and a sink device with a DisplayPort interface.

The source device includes a storage circuit for storing and providing an updated firmware, and an output circuit that outputs a signal with a predetermined signal format for outputting the updated firmware with the predetermined signal format.

The sink device includes a main link, a sink device auxiliary channel, the sink device receiving the updated firmware with the predetermined signal format using at least two pins of the main link and the sink device auxiliary channel, a selector circuit coupled to the main link and the sink device auxiliary channel for outputting the updated firmware with the predetermined signal format, and a memory unit for updating firmware according to the updated firmware with the predetermined signal format.

According to still another aspect of the present invention, there is provided a system for updating firmware through a DisplayPort interface. The system comprises a source device with a transmission interface distinct from DisplayPort interface, and a sink device with a DisplayPort interface.

The source device includes a storage circuit for storing and providing an updated firmware, and an output circuit that outputs a signal with a predetermined signal format and that is coupled to the storage circuit for outputting, via the transmission interface, the updated firmware with the predetermined signal format.

The sink device includes a firmware update channel, that is independent of standard channels of the DisplayPort interface of the sink device, for receiving the updated firmware with the predetermined signal format, and a memory unit coupled to the firmware update channel for updating firmware according to the updated firmware with the predetermined signal format.

According to still another aspect of the present invention, there is provided a system for updating firmware through a DisplayPort interface. The system comprises a first source device with a DisplayPort interface for providing DisplayPort interface signals, a second source device with a transmission interface distinct from DisplayPort interface, a signal combining device, and a sink device with a DisplayPort interface.

The second source device includes a storage circuit for storing and providing an updated firmware, and an output circuit that outputs a signal with a predetermined signal format and that is coupled to the storage circuit for outputting the updated firmware with the predetermined signal format.

The signal combining device is coupled to the first and second source devices for combining the DisplayPort interface signals from the first source device and the updated firmware with the predetermined signal format from the second source device into a combined signal.

The sink device is coupled to the signal combining device and includes a signal splitting circuit for extracting the updated firmware with the predetermined signal format from the combined signal, and a memory unit for updating firmware according to the updated firmware with the predetermined signal format.

This invention is suitable for use by a multimedia application with a DisplayPort format in updating firmware stored in a memory unit formicro-tuning quality of a display screen or performing other display operations.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic diagram of a transmission framework of a DisplayPort interface;

FIG. 2 is a diagram of the layer structure of the DisplayPort interface;

FIG. 3 is a simplified diagram of FIG. 2;

FIG. 4 is a schematic diagram of a first preferred embodiment of a system for updating firmware according to the present invention;

FIG. 5 is a schematic diagram of a modification of the first preferred embodiment;

FIG. 6 is a schematic diagram of a second preferred embodiment of a system for updating firmware according to the present invention;

FIG. 7 is a schematic diagram of a modification of the second preferred embodiment;

FIG. 8 is a schematic diagram of a third preferred embodiment of a system for updating firmware according to the present invention;

FIG. 9 is a schematic diagram of a modification of the third preferred embodiment;

FIG. 10 is a schematic diagram of a fourth preferred embodiment of a system for updating firmware according to the present invention; and

FIG. 11 is a schematic diagram of a modification of the fourth preferred embodiment.

### DETAILED DESCRIPTION OF THE PREFERRED EMBODIMENTS

In the following description, the framework of DisplayPort will be introduced first, to be followed by how firmware of a display control device based thereon is updated. It should be noted herein that, although the preferred embodiments of this invention are employed to update firmware of a display control device, nevertheless, the present invention is not limited in this aspect. Any firmware update performed by the methods disclosed in this invention is covered by the scope sought to be protected by this invention.

Before the present invention is described in greater detail with reference to the accompanying preferred embodiments, it should be noted herein that like elements are denoted by the same reference numerals throughout the disclosure.

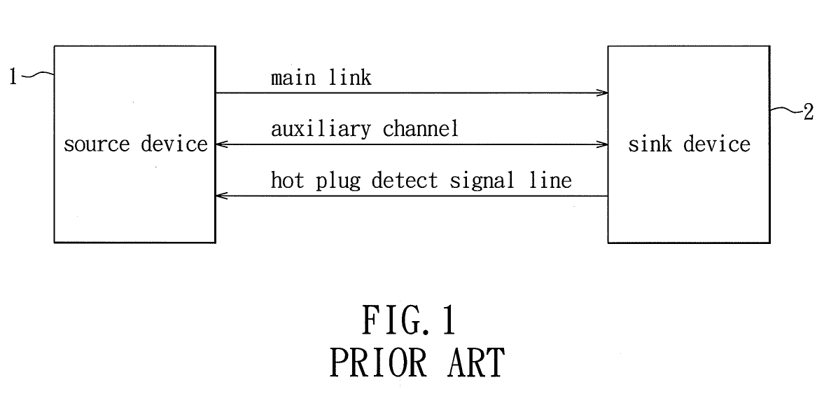

Referring to FIG. 1, a transmission framework of a DisplayPort interface is shown to comprise a source device 1 and a sink device 2, each of which includes three communication channels: a main link, an auxiliary channel (AUX-CH), and a hot plug detect (HPD) signal line. The main link consists of one, two, or four alternating-current coupled (AC-coupled) differential pairs called lanes. Each main link lane is used for unidirectional transmission of clock signals and audio-visual data. The auxiliary channel consists of an AC-coupled differential pair used for bidirectional transmission of status information and control commands. The hot plug detect signal line is used to service an interrupt request from the sink device 2.

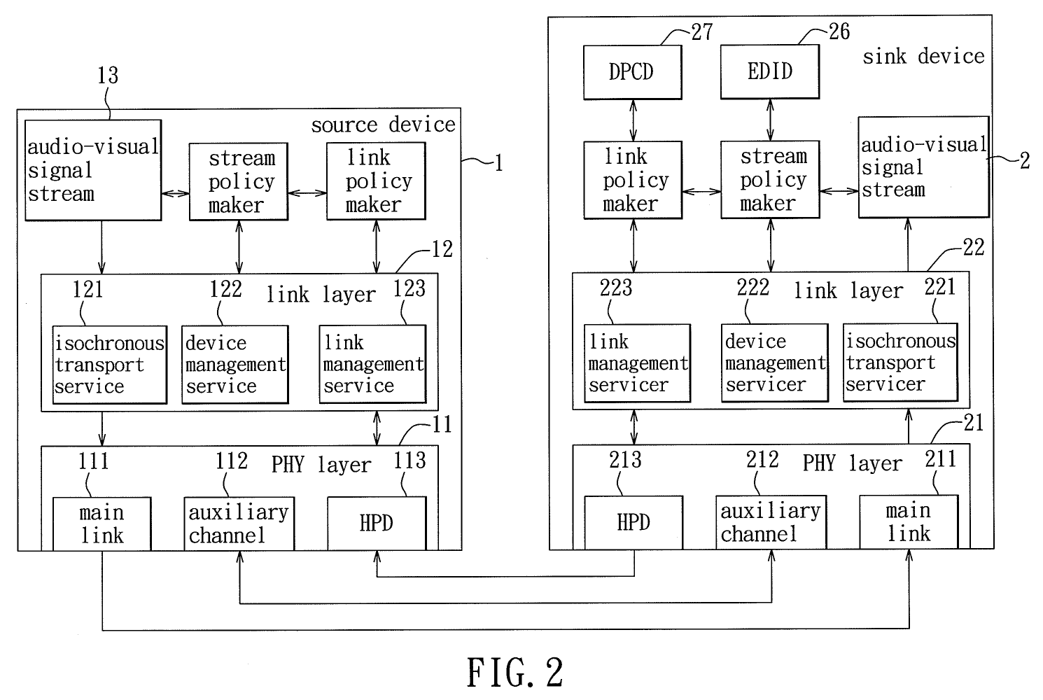

Referring to FIG. 2, a layer structure of the DisplayPort interface is shown to include a physical (PHY) layer 11,21 and a link layer 12,22. The physical layer 11,21 comprises the three aforementioned communication channels: the main link 111,211, the auxiliary channel 112,212, and the hot plug detect signal line (HPD) 113, 213. The link layer 12,22 is mainly used for performing isochronous transport services 121, 221 over the main link 111, 211, and link and device management services 122,123,222,223 over the auxiliary channel 112, 212.

The aforementioned isochronous transport services 121,221 are used to transmit an audio-visual signal stream 13 from the source device 1 to the sink device 2 through the main links 111,211 in accordance with a predetermined rule such that the sink device 2 is able to reconstruct the original format and time base of the audio-visual stream 13. The aforementioned link and device management services 122,123,222,223 are used to access DisplayPort Configuration Data (DPCD) 27 and Extended Display Identification Data (EDID) 26 of the sink device 2 over the auxiliary channels 112,212, so as to identify work capability and status of the sink device 2, and to maintain links and provide device-level applications. It should be noted herein that, since FIG. 2 is excerpted from the DisplayPort Standard, each functional block shown in the Figure is well known to those skilled in the art, and hence will not be further detailed for the sake of brevity.

Since the DisplayPort interface does not include a conventional display data channel, the conventional method of updating firmware of a display control device of a display apparatus cannot be employed. In view of this, the present invention provides a method for updating firmware of a display control device in a DisplayPort application.

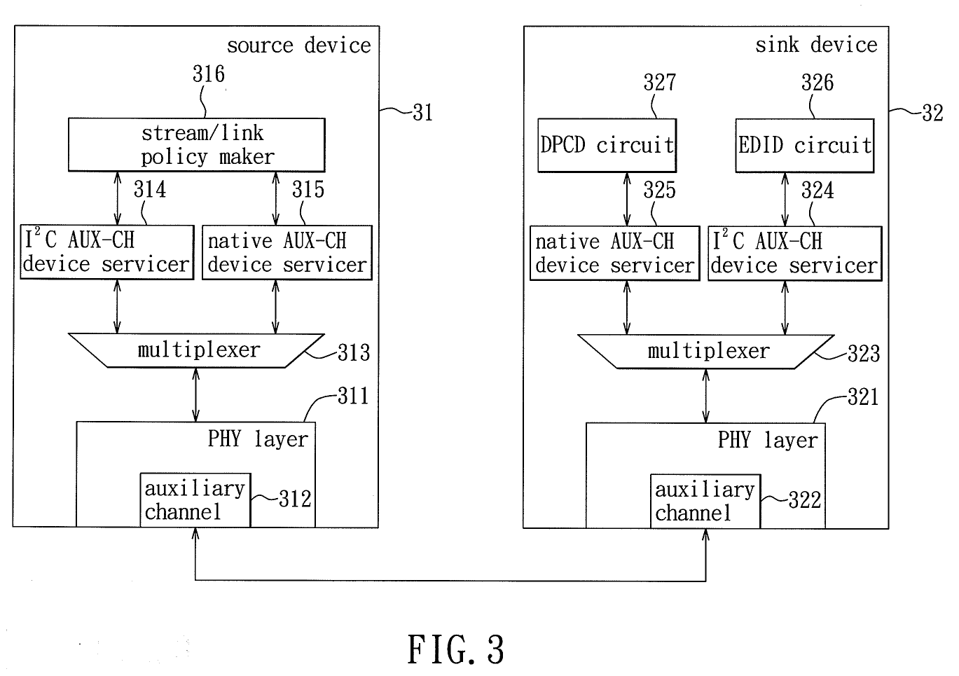

Since the first preferred embodiment of the present invention uses the auxiliary channels 112,212 of the DisplayPort interface for updating firmware stored in the sink device 2, relevant illustrations are simplified to focus on the auxiliary channels 112,212. Accordingly, FIG. 2 has been simplified into FIG. 3.

Referring to FIG. 3, a source device 31 and a sink device 32 of a DisplayPort system are shown. The source device 31 includes a stream/link policy maker 316, an Inter-Integrated Circuit (I²C) AUX-CH device servicer 314, a native AUX-CH device servicer 315, a multiplexer 313, and a physical (PHY) layer 311 provided with a source device auxiliary channel 312. The sink device 32 includes a physical (PHY) layer 321 provided with a sink device auxiliary channel 322, a multiplexer 323, a native AUX-CH device servicer 325, an I²C AUX-CH device servicer 324, a DisplayPort Configuration Data (DPCD) Circuit 327 and an Extended Display Identification Data (EDID) circuit 326.

In this embodiment, when it is intended to drive the source device 31 to update firmware stored in a memory unit of the display control device of the sink device 32, the I²C AUX-CH device servicer 314 of the source device 31 is used to transmit an updated firmware with an auxiliary channel signal format to the I²C AUX-CH device servicer 324 of the sink device 32, wherein the process and manner of signal transmission complies with the DisplayPort standard, and is well known to those skilled in the art.

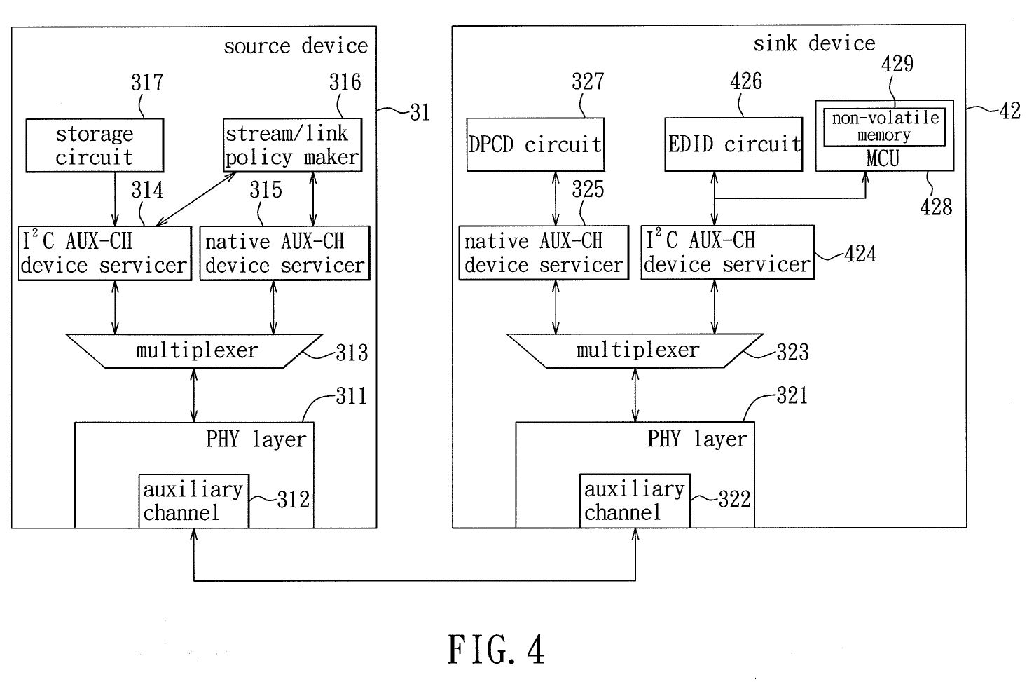

Referring to FIG. 4, when the I²C AUX-CH device servicer 424 of the sink device 42 receives the updated firmware, if the memory unit in which the updated firmware is to be stored comprises the EDID circuit 426 and a non-volatile memory 429 which is built into a micro controller unit (MCU) 428, the I²C AUX-CH device servicer 424 of the sink device 42 transmits the data of updated firmware originating from a storage circuit 317 of the source device 31 to the EDID circuit 426 and the MCU 428 for updating the present firmware.

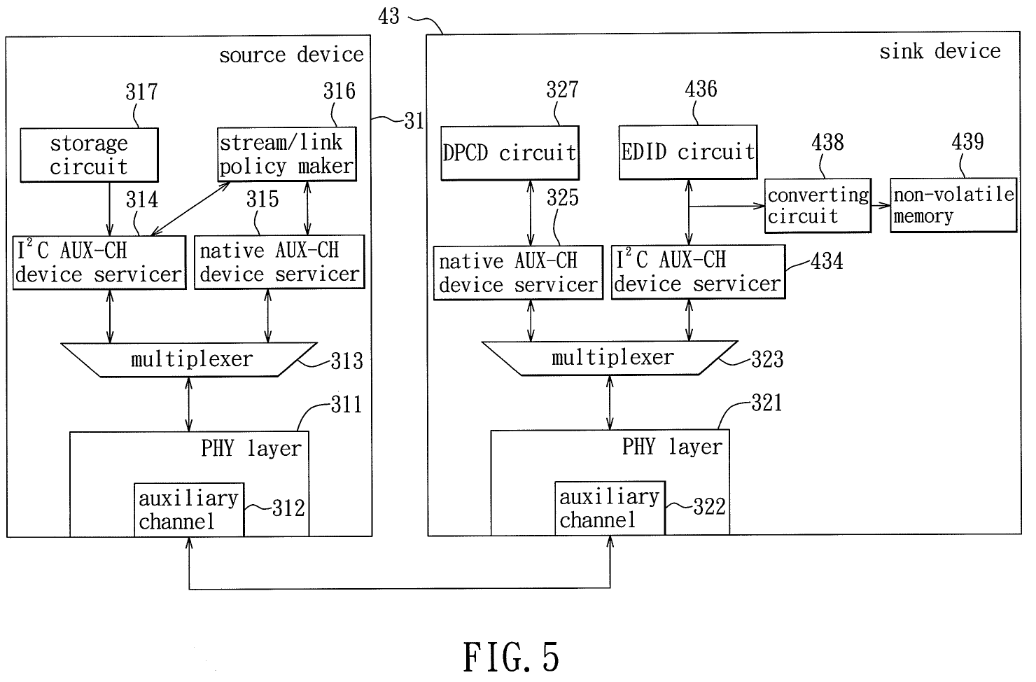

Referring to FIG. 5, if the memory unit in which the updated firmware is to be stored includes the EDID circuit 436 and a non-volatile memory 439, such as a flash memory, coupled externally to the MCU 428 (shown in FIG. 4), the I²C AUX-CH device servicer 434 of the sink device 43 transmits the data of updated firmware to the EDID circuit 436 and a converting circuit 438. The converting circuit 438 is responsible for converting the data protocol of updated firmware that complies with the I²C protocol into a data protocol which the non-volatile memory 439 is capable of handling, so that the protocol-converted data may be outputted to the non-volatile memory 439 for updating the present firmware.

It should be noted herein that, since the I²C protocol is a known protocol, use of the MCU 428 to process data complying with the I²C protocol and store the processed data in built-in non-volatile memory 429, and use of the converting circuit 438 to convert the data protocol of updated firmware from the I²C protocol into a currently known data protocol should be techniques readily appreciated and easily implemented by those skilled in the art, and hence are not described hereinafter for the sake of brevity. Moreover, the aforementioned non-volatile memory 429,439 can be fabricated to handle data complying with the I²C protocol through an appropriate conventional design.

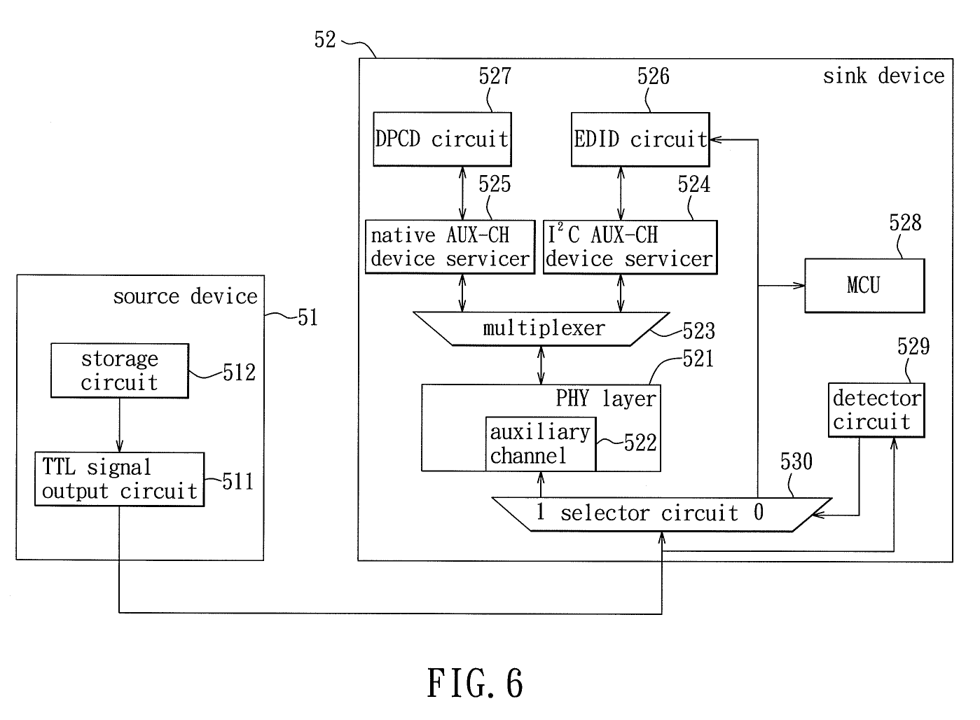

The second preferred embodiment of the present invention uses any two pins from the main link and the auxiliary channel to transmit data of updated firmware to the sink device 52 with a DisplayPort interface (see FIG. 6). It should be noted herein that, in this embodiment, the device providing data of updated firmware does not have a DisplayPort interface, but another type of transmission interface such as Line Print Terminal (LPT) interface or COM interface.

Referring to FIG. 6, the source device 51 is shown to include a storage circuit 512 for outputting firmware complying with the I²C protocol, and an output circuit that outputs a signal with a predetermined format. In this embodiment, the output circuit that outputs the signal with a predetermined signal format is a Transistor-Transistor Level (TTL) signal output circuit 511. The TTL signal output circuit 511 is coupled to the storage circuit 512 for converting the updated firmware from an original signal format (which is a known conventional signal format) into a TTL signal format. Realization of the TTL signal output circuit 511 is a well-known art.

The sink device 52 includes, as mentioned hereinbefore, a physical (PHY) layer 521 provided with a sink device auxiliary channel 522, a multiplexer 523, a native AUX-CH device servicer 525, an I²C AUX-CH device servicer 524, a DPCD circuit 527, and an EDID circuit 526. The sink device 52 of this embodiment further includes a detector circuit 529 for determining whether a signal outputted from the source device 51 is a TTL-compliant signal or a small signal complying with the DisplayPort interface, and a selector circuit 530 for receiving the same signal from the source device 51 and, in accordance with a detection result of the detector circuit 529, outputting the small signal to the physical (PHY) layer 521 provided with the auxiliary channel 522 or outputting the TTL-compliant signal to a memory unit that includes the EDID circuit 526 and an MCU 528. Since TTL signal format and DisplayPort signal format are known signal formats, realization of the aforementioned detector circuit 529 should be readily appreciated by those skilled in the art, and hence will not be further detailed for the sake of brevity.

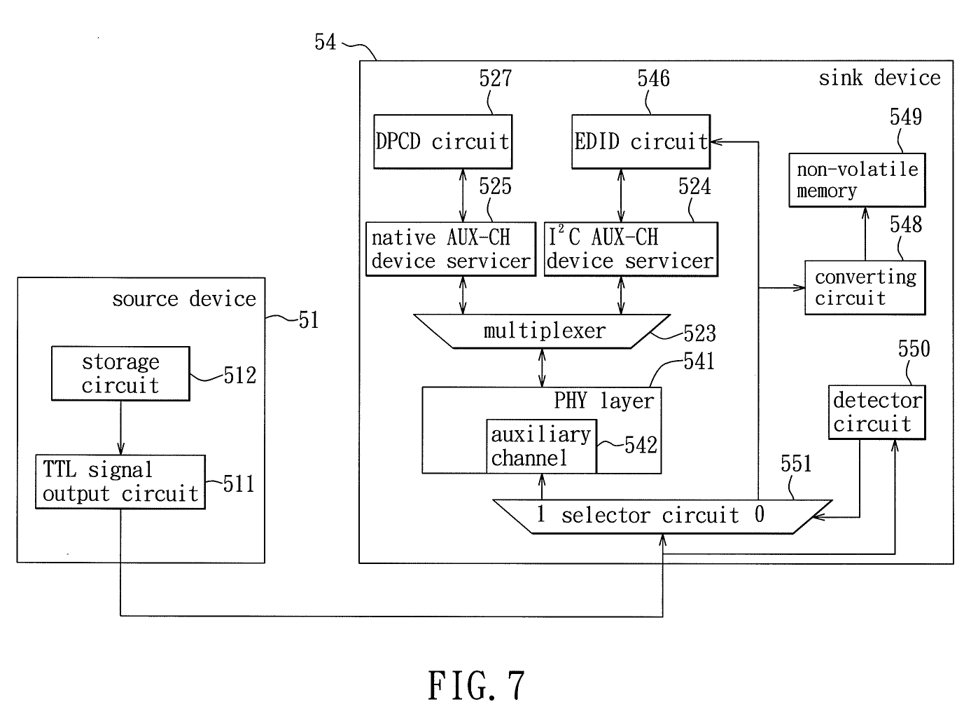

Referring to FIG. 7, a modification of the second preferred embodiment is shown to differ from that of FIG. 6 in that a non-volatile memory 549, such as a flash memory, resides outside the EDID circuit 546 and the MCU 528 (shown in FIG. 6) of the sink device 54. The selector circuit 551 outputs the TTL-compliant signal to the memory unit, that is, the EDID circuit 546 and a converting circuit 548, wherein the converting circuit 548 converts the data protocol of the updated firmware from the I²C compliant protocol into a data protocol that the non-volatile memory 549 is capable of handling, so that the protocol-converted data can be outputted to the non-volatile memory 549 for updating the present firmware. In addition, the aforementioned non-volatile memory 549 can be fabricated to handle data complying with the I²C protocol through an appropriate conventional design.

The detector circuit 529,550 used in FIG. 6 or FIG. 7 can be replaced by a register controlled by software or hardware to have a value of ‘0’ or ‘1’. When firmware updating is to be performed, the value of the register is set to ‘0’ by a user or an automatic control mechanism such that the selector circuits 530,551 of FIGS. 6 and 7 provide the signal outputted from the source device 51 to the MCU 528 of FIG. 6 and the converting circuit 548 of FIG. 7, respectively. When an operation other than a firmware update is to be performed, the value of the register is set to ‘1’ such that the selector circuits 530,551 of FIGS. 6 and 7 provide the signal outputted from the source device 51 to the physical (PHY) layer 521 provided with the auxiliary channel 522 and the physical (PHY) layer 541 provided with the auxiliary channel 542, respectively. It is noted that when used to replace the detector circuit 529,550, the register does not need to receive and perform detection on signals outputted from the source device 51.

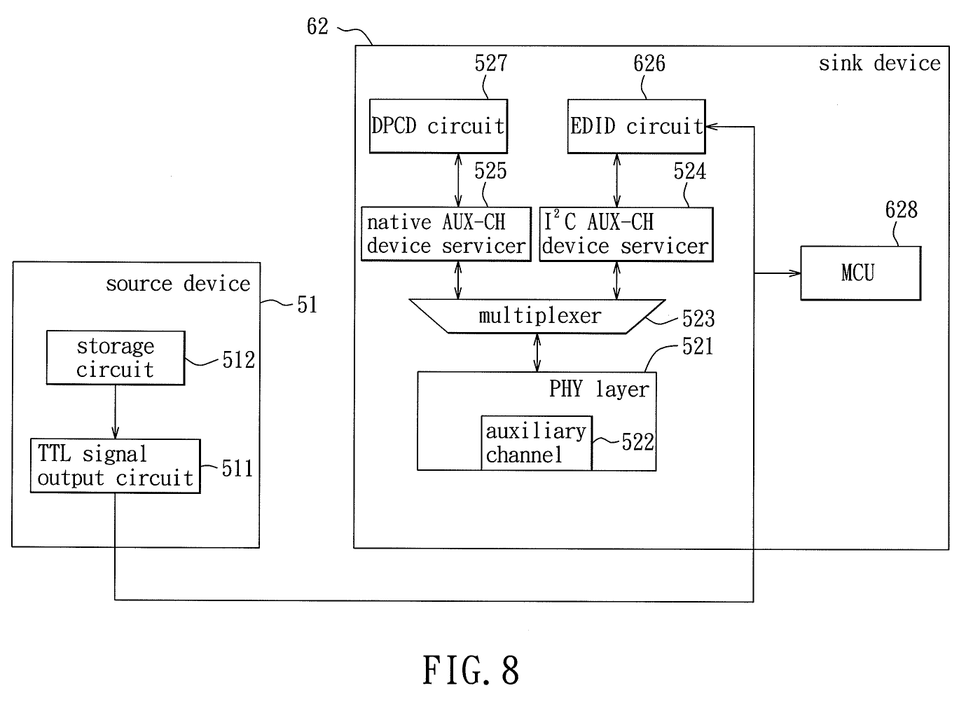

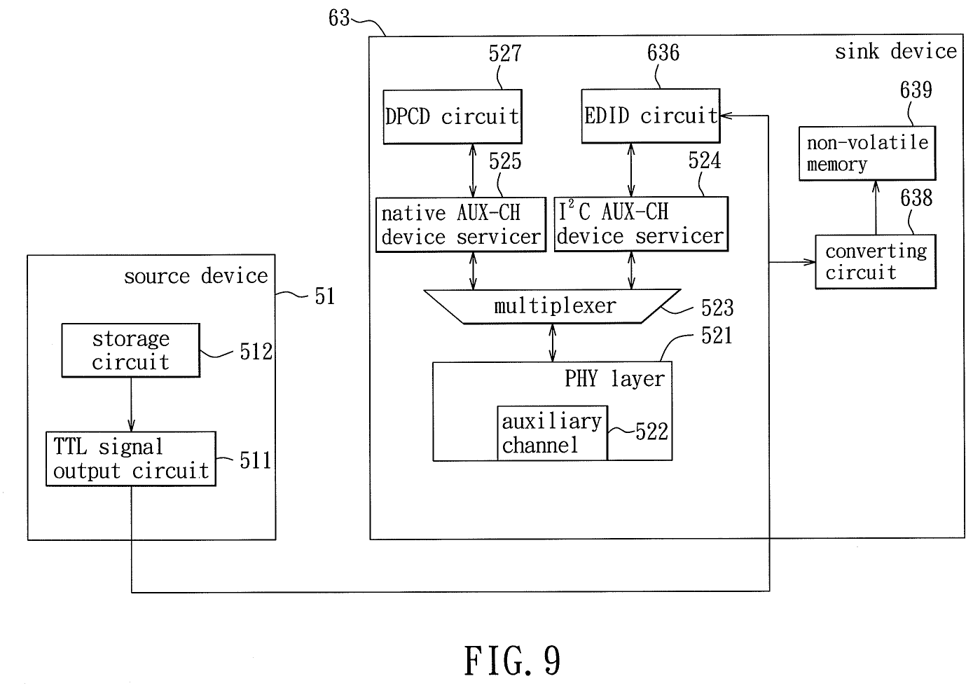

Referring further to FIGS. 8 and 9 of a third preferred embodiment of the present invention and again to FIGS. 6 and 7 of the second preferred embodiment, the main difference between these two preferred embodiments resides in that the second preferred embodiment uses any two pins from the main link and the auxiliary channel for transmitting data of updated firmware to the sink device 52,54, whereas the third preferred embodiment uses two additional pins as firmware update channels of the sink device 62,63 for transmitting data of updated firmware directly to the memory unit, that is, the EDID circuit 626 and the MCU 628 of FIG. 8, and the EDID circuit 636 and the converting circuit 638 of FIG. 9. In this manner, generation of a detection result by the detector circuit 529,550 and performance of corresponding control by the selector circuit 530,551 are rendered unnecessary (see FIGS. 6 and 7). Since the operation of the embodiments of FIGS. 8 and 9 is similar to that of the previous embodiments, further details will be omitted.

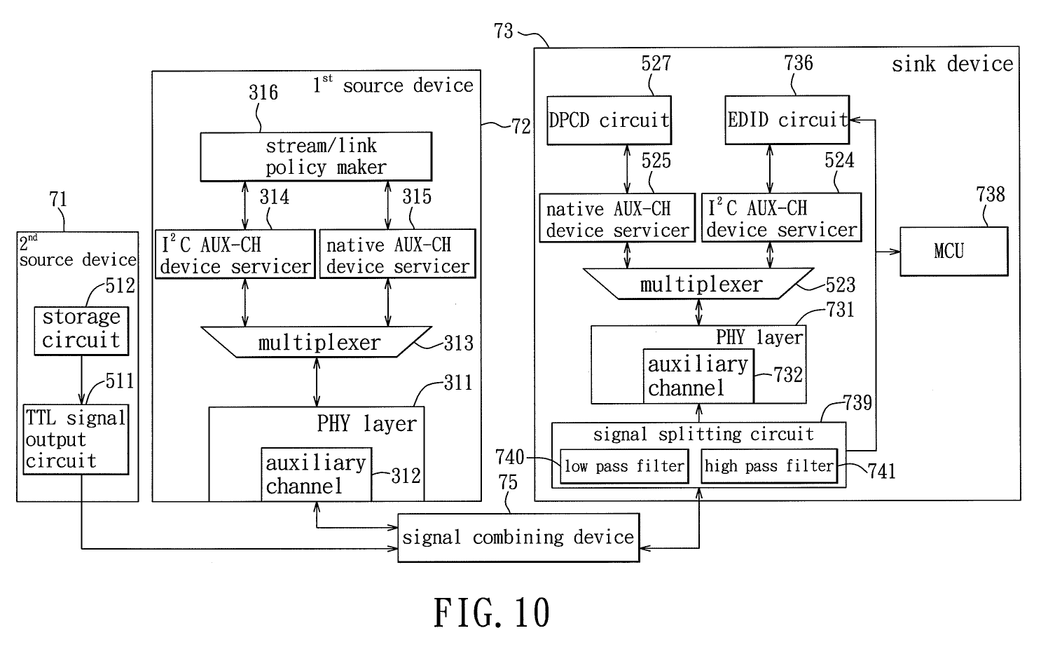

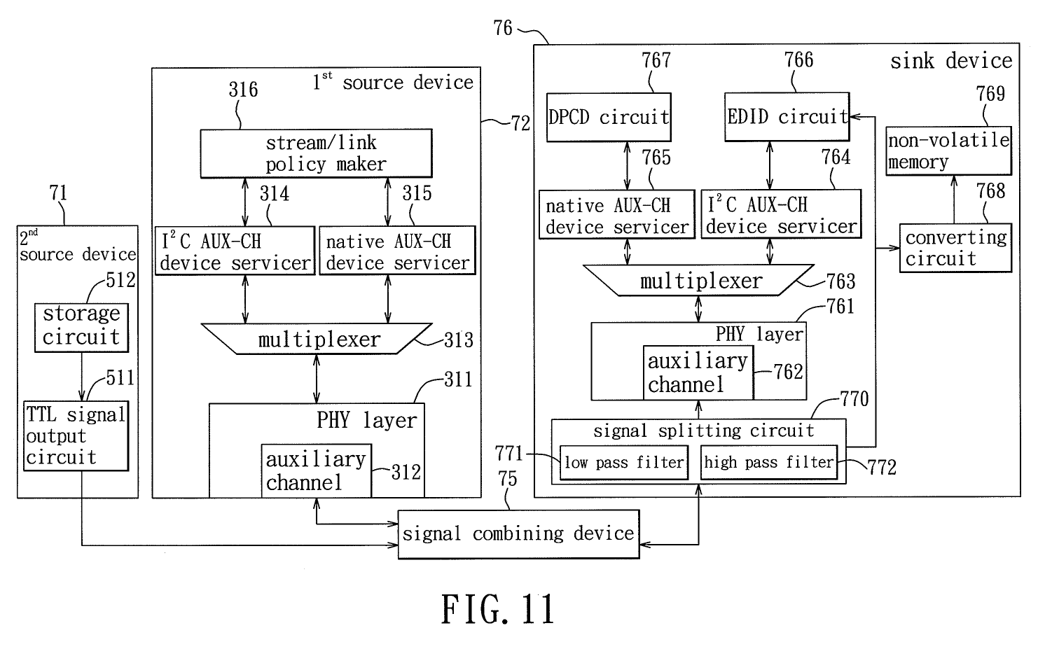

Referring to FIGS. 10 and 11, a fourth preferred embodiment of the present invention is shown to comprise a first source device 72 with a DisplayPort interface, a sink device 73,76 with a DisplayPort interface, a second source device 71 that has another type of transmission interface such as Line Print Terminal (LPT) interface or COM interface, and a signal combining device 75.

The signal combining device 75 receives signals outputted from the first source device 72 and I²C signals outputted from the second source device 71 having another type of transmission interface. The I²C signals include data of updated firmware. The signal combining device 75 combines the signals from the two source devices 71,72 for subsequent output to the sink device 73,76 through any two pins of the main link and the auxiliary channel. Since realization of the signal combining device 75 for combining signals from two sources is a well known art, details thereof are omitted herein.

The sink device 73,76 includes a signal splitting circuit 739,770 for extracting from the combined signal the signal component originated from the first source device 72 and for outputting the same to the physical (PHY) layer 731,761 provided with the auxiliary channel 732,762, and for extracting from the combined signal the signal component originated from the second source device 71 that has another type of transmission interface and for outputting the same to the memory unit, that is, the EDID circuit 736 and the MCU 738 of FIG. 10, and the EDID circuit 766 and the converting circuit 768 of FIG. 11.

In this embodiment, frequencies of signals originating from the first source device 72 are far higher than those originating from the second source device 71 that has another type of transmission interface. Hence, the signal splitting circuit 739,770 may employ a filter circuit with a specific frequency response to split the combined signals. For instance, in this embodiment, the frequency of signals from the first source device 72 is 100 MHz, whereas the frequency of signals from the second source device 71 that has another type of transmission interface is 1 MHz. The signal spitting circuit 739,770 may therefore employ a combination of a low pass filter 740,771 and a high pass filter 741,772 having a cut-off frequency of 10 MHz for signal splitting of the combined signal. Since other circuits included in this embodiment are already described in the previous embodiments, details thereof are omitted herein for the sake of brevity.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method for updating firmware through a DisplayPort interface, said method comprising the steps of:
providing a source device with a DisplayPort interface,
the source device including
a storage circuit for storing and providing an updated firmware, and
a source device auxiliary channel for outputting the updated firmware with an auxiliary channel signal format;
providing a sink device with a DisplayPort interface,
the sink device including
a sink device auxiliary channel for receiving the updated firmware with the auxiliary channel signal format and thereby generating an output signal,
an Inter-Integrated Circuit (I²C) auxiliary channel device servicer coupled to the sink device auxiliary channel for receiving the output signal and generating an I²C protocol updated firmware, and
a memory unit for updating firmware according to the I²C protocol updated firmware; and
updating firmware of the memory unit through the source device auxiliary channel and the sink device auxiliary channel.

2. The method as claimed in claim 1, wherein the memory unit is embedded in a micro controller unit.

3. The method as claimed in claim 1, wherein the sink device further includes a converting circuit for converting a data protocol of the I²C protocol updated firmware into a data protocol which the memory unit is capable of handling.

4. A method for updating firmware through a DisplayPort interface, said method comprising the steps of:
providing a source device with a transmission interface distinct from a DisplayPort interface, the source device including
a storage circuit for storing and providing an updated firmware, and
an output circuit that outputs a signal with a predetermined signal format for outputting the updated firmware with the predetermined signal format;
providing a sink device with a DisplayPort interface,
the sink device including
a main link,
a sink device auxiliary channel, the sink device using at least two pins of the main link and the sink device auxiliary channel to receive the updated firmware with the predetermined signal format,
a selector circuit coupled to the main link and the sink device auxiliary channel for outputting the updated firmware with the predetermined signal format, and
a memory unit for updating firmware according to the updated firmware with the predetermined signal format; and
updating firmware of the memory unit through said at least two pins of the main link and the sink device auxiliary channel.

5. The method as claimed in claim 4, wherein the memory unit is embedded in a micro controller unit.

6. The method as claimed in claim 4, wherein the sink device further includes a converting circuit for converting a data protocol of the updated firmware with the predetermined signal format into a data protocol which the memory unit is capable of handling.

7. The method as claimed in claim 4, wherein the data protocol of the updated firmware with the predetermined signal format is an I²C data protocol.

8. The method as claimed in claim 4, wherein the sink device further includes a detector circuit coupled to the main link, the sink device auxiliary channel and the selector circuit for detecting whether a signal received by said at least two pins of the main link and the sink device auxiliary channel has the predetermined signal format and accordingly controlling the selector circuit.

9. A method for updating firmware of a sink device with a DisplayPort interface, said method comprising the steps of:
providing a source device with a transmission interface distinct from a DisplayPort interface, the source device including
a storage circuit for storing and providing an updated firmware, and
an output circuit that outputs a signal with a predetermined signal format for outputting, via the transmission interface, the updated firmware with the predetermined signal format;
providing a sink device with a DisplayPort interface,
the sink device including
a firmware update channel, that is independent of standard channels of the DisplayPort interface of the sink device, for receiving the updated firmware with the predetermined signal format, and
a memory unit coupled to the firmware update channel for updating firmware according to the updated firmware with the predetermined signal format; and
updating firmware of the memory unit through the transmission interface of the source device and the firmware update channel of the sink device.

10. The method as claimed in claim 9, wherein the memory unit is embedded in a micro controller unit.

11. The method as claimed in claim 9, wherein the sink device further includes a converting circuit for converting a data protocol of the updated firmware with the predetermined signal format into a data protocol which the memory unit is capable of handling.

12. The method as claimed in claim 9, wherein the data protocol of the updated firmware with the predetermined signal format is an I²C data protocol.

13. A method for updating firmware using a DisplayPort interface, said method comprising the steps of:
providing a first source device with a DisplayPort interface for providing DisplayPort interface signals;
providing a second source device with a transmission interface distinct from a Displayport interface, the second source device including
a storage circuit for storing and providing an updated firmware, and
an output circuit that outputs a signal with a predetermined signal format for outputting the updated firmware with the predetermined signal format;
providing a signal combining device that is coupled to the first and second source devices for combining the DisplayPort interface signals from the first source device and the updated firmware with the predetermined signal format from the second source device into a combined signal; and
providing a sink device with a DisplayPort interface,
the sink device being coupled to the signal combining device and including
a signal splitting circuit for extracting the updated firmware with the predetermined signal format from the combined signal, and
a memory unit for updating firmware according to the updated firmware with the predetermined signal format.

14. The method as claimed in claim 13, wherein the memory unit is embedded in a micro controller unit.

15. The method as claimed in claim 13, wherein the sink device further includes a converting circuit for converting a data protocol of the updated firmware with the predetermined signal format into a data protocol which the memory unit is capable of handling.

16. The method as claimed in claim 13, wherein the data protocol of the updated firmware with the predetermined signal format is an I²C data protocol.

17. The method as claimed in claim 13, wherein the signal splitting circuit is a filter circuit.

18. The method as claimed in claim 17, wherein the filter circuit includes a low pass filter and a high pass filter.

19. A system for updating firmware through a DisplayPort interface, said system comprising:
a source device with a DisplayPort interface, said source device including
a storage circuit for storing and providing an updated firmware, and
a source device auxiliary channel for outputting the updated firmware with an auxiliary channel signal format; and
a sink device with a DisplayPort interface, said sink device including
a sink device auxiliary channel for receiving the updated firmware with the auxiliary channel signal format and thereby generating an output signal,
an Inter-Integrated Circuit (I²C) auxiliary channel device servicer coupled to said sink device auxiliary channel for receiving the output signal and generating an I²C protocol updated firmware, and
a memory unit for updating firmware according to the I²C protocol updated firmware.

20. The system for updating firmware as claimed in claim 19, wherein said sink device further includes a micro controller unit, and said memory unit is embedded in said micro controller unit.

21. The system for updating firmware as claimed in claim 19, wherein said sink device further includes a converting circuit for converting a data protocol of the I²C protocol updated firmware into a data protocol which said memory unit is capable of handling.

22. A system for updating firmware through a DisplayPort interface, said system comprising:
a source device with a transmission interface distinct from DisplayPort interface, said source device including
a storage circuit for storing and providing an updated firmware, and
an output circuit that outputs a signal with a predetermined signal format for outputting the updated firmware with the predetermined signal format; and
a sink device with a DisplayPort interface, said sink device including
a main link,
a sink device auxiliary channel, said sink device receiving the updated firmware with the predetermined signal format using at least two pins of said main link and said sink device auxiliary channel,
a selector circuit coupled to said main link and said sink device auxiliary channel for outputting the updated firmware with the predetermined signal format, and
a memory unit for updating firmware according to the updated firmware with the predetermined signal format.

23. The system for updating firmware as claimed in claim 22, wherein said sink device further includes a micro controller unit, and said memory unit is embedded in said micro controller unit.

24. The system for updating firmware as claimed in claim 22, wherein said sink device further includes a converting circuit for converting a data protocol of the updated firmware with the predetermined signal format into a data protocol which said memory unit is capable of handling.

25. The system for updating firmware as claimed in claim 22, wherein the data protocol of the updated firmware with the predetermined signal format is an I²C data protocol.

26. The system for updating firmware as claimed in claim 22, wherein said sink device further includes a detector circuit coupled to said main link, said sink device auxiliary channel, and said selector circuit for detecting whether a signal received by said at least two pins of said main link and said sink device auxiliary channel has the predetermined signal format and accordingly controlling said selector circuit.

27. A system for updating firmware through a DisplayPort interface, said system comprising:
a source device with a transmission interface distinct from DisplayPort interface, said source device including
a storage circuit for storing and providing an updated firmware, and
an output circuit that outputs a signal with a predetermined signal format and that is coupled to said storage circuit for outputting, via the transmission interface, the updated firmware with the predetermined signal format; and
a sink device with a DisplayPort interface, said sink device including
a firmware update channel, that is independent of standard channels of the DisplayPort interface of said sink device, for receiving the updated firmware with the predetermined signal format, and
a memory unit coupled to said firmware update channel for updating firmware according to the updated firmware with the predetermined signal format.

28. The firmware updating system as claimed in claim 27, wherein said sink device further includes a micro controller unit, and said memory unit is embedded in said micro controller unit.

29. The system for updating firmware as claimed in claim 27, wherein said sink device further includes a converting circuit for converting a data protocol of the updated firmware with the predetermined signal format into a data protocol which said memory unit is capable of handling.

30. The system for updating firmware as claimed in claim 27, wherein the data protocol of the updated firmware with the predetermined signal format is an I²C data protocol.

31. A system for updating firmware through a DisplayPort interface, said system comprising:
a first source device with a DisplayPort interface for providing DisplayPort interface signals;
a second source device with a transmission interface distinct from DisplayPort interface, said second source device including
a storage circuit for storing and providing an updated firmware, and
an output circuit that outputs a signal with a predetermined signal format for outputting the updated firmware with the predetermined signal format;
a signal combining device that is coupled to said first and second source devices for combining the DisplayPort interface signals from said first source device and the updated firmware with the predetermined signal format from said second source device into a combined signal; and
a sink device with a DisplayPort interface, said sink device being coupled to said signal combining device and including
a signal splitting circuit for extracting the updated firmware with the predetermined signal format from the combined signal, and
a memory unit for updating firmware according to the updated firmware with the predetermined signal format.

32. The system for updating firmware as claimed in claim 31, wherein said sink device further includes a micro controller unit, and said memory unit is embedded in said micro controller unit.

33. The system for updating firmware as claimed in claim 31, wherein said sink device further includes a converting circuit for converting a data protocol of the I²C protocol updated firmware with the predetermined signal format into a data protocol which said memory unit is capable of handling.

34. The system for updating firmware as claimed in claim 31, wherein the data protocol of the updated firmware with the predetermined signal format is an I²C data protocol.

35. The system for updating firmware as claimed in claim 31, wherein said signal splitting circuit is a filter circuit.

36. The system for updating firmware as claimed in claim 35, wherein said filter circuit includes a low pass filter and a high pass filter.
